(19) United States
(12) Patent Application Publication
(10) Pub. No.: US 2025/0361151 A1
(43) Pub. Date: Nov. 27, 2025

(54) SYSTEM AND METHOD FOR PRODUCING CYROLITE

(71) Applicants: Taiwan Semiconductor Manufacturing Co., Ltd., Hsinchu (TW); ReTech Environmental Solutions Co., Jhubei City (TW)

(72) Inventors: You-Shiun LIN, Hsinchu (TW); Chao-Chun CHANG, Hsinchu (TW); Kuo-Wei CHEN, Hsinchu (TW); Yi-Chen LI, Hsinchu (TW); Tsung Lung LU, Hsinchu (TW)

(73) Assignees: Taiwan Semiconductor Manufacturing Co., Ltd., Hsinchu (TW); ReTech Environmental Solutions Co., Jhubei City (TW)

(21) Appl. No.: 19/292,723

(22) Filed: Aug. 6, 2025

Related U.S. Application Data
(63) Continuation of application No. 18/412,303, filed on Jan. 12, 2024.
(60) Provisional application No. 63/517,226, filed on Aug. 2, 2023.

(51) Int. Cl. C01F 7/54

(52) U.S. Cl. CPC C01F 7/54; C01P 2006/40

(57) ABSTRACT

Hydrofluoric acid waste streams from semiconductor device manufacturing processes are collected and converted to cryolite utilizing disclosed systems and processes. The systems and processes are able to utilize hydrofluoric acid waste streams from multiple different sources. The systems and processes control delivery of reactant so that the produced cryolite has low impurity levels and meets industry standards.

### PRIORITY CLAIM

This application is a continuation application of U.S. Non-Provisional patent application Ser. No. 18/412,303 filed Jan. 12, 2024, and claims benefit of U.S. Provisional Patent Application No. 63/517,226 filed on Aug. 2, 2023, which are incorporated by reference herein in their entirety.

### BACKGROUND

In the semiconductor integrated circuit (IC) industry, technological advances in IC materials and design have produced generations of ICs where each generation has smaller and more complex circuits than the previous generation. In the course of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs. Such scaling down has also increased the complexity of IC processing and manufacturing.

Hydrofluoric acid (HF solution) is used in an etching and cleaning steps that are regularly carried out in the manufacture of semiconductor devices. Such hydrofluoric acid presents challenges when it comes to reuse or disposal. For example, disposal of hydrofluoric acid presents environmental challenges. Reuse of the hydrofluoric acid can involve further processing that can be expensive and yield less than desirable products.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic piping and instrumentation diagram of a system for converting hydrofluoric acid waste to cryolite in accordance with embodiments of the present disclosure.

FIG. 2 is a schematic view of the system of FIG. 1.

FIG. 2A is a schematic view of another embodiment of the system of FIGS. 1 and 2.

FIG. 2B is a schematic view of another embodiment of the systems of FIGS. 1 and 2.

FIG. 3 is a schematic view of a system for converting hydrofluoric acid waste to cryolite in accordance with an alternative embodiment of the present disclosure.

FIG. 4 is a flow chart of a method for converting waste hydrofluoric acid to cryolite in accordance with embodiments of the present disclosure.

FIG. 5 is a flow chart of an alternative method for converting waste hydrofluoric acid to cryolite in accordance with embodiments of the present disclosure.

FIG. 6 is a flow chart of an alternative method for converting waste hydrofluoric acid to cryolite in accordance with embodiments of the present disclosure.

FIG. 7 is a flow chart of a method for utilizing thermal energy generated by converting waste hydrofluoric acid to cryolite in accordance with embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the following description, certain specific details are set forth in order to provide a thorough understanding of various embodiments of the disclosure. However, one skilled in the art will understand that the disclosure may be practiced without these specific details. In other instances, well-known structures associated with electronic components and fabrication techniques have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second and third does not necessarily imply a ranked sense of order, but rather may only distinguish between multiple instances of an act or structure.

Reference throughout this specification to “one embodiment” or “an embodiment” means that a particular feature, structure or characteristic described in connection with the embodiment is included in at least some embodiments. Thus, the appearances of the phrases “in one embodiment”, “in an embodiment”, or “in some embodiments” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Hydrogen fluoride (HF) is an important chemical in the manufacture of semiconductor devices. Gaseous hydrogen fluoride, also known as ‘etching gas’, is a compound created by the bonding of a hydrogen (H) atom with a fluorine (F). HF is highly reactive and can etch silicon based solids and polymers used in the manufacture of semiconductor devices. HF has a boiling point of 19.5° C., and exists as a gas at room temperature (25° C.). However, it can be easily liquefied under pressure or at sufficiently cool temperatures. HF is also highly water soluble. An aqueous solution of HF is known as hydrofluoric acid. Hydrofluoric acid is used in the ‘etching’ and ‘cleaning’ steps in the manufacture of semiconductor devices. In an etching step, the role of hydrofluoric acid can be described as ‘printmaking’. Printmaking involves printing a drawing into a wooden surface, then using a carving knife to carve out the non-drawing portions of the surface. Hydrofluoric acid works like a carving knife, etching away the unwanted parts of a wafer. Hydrofluoric acid also has a use in cleaning processes of semiconductor device manufacturing. Even the tiniest impurity can adversely affect the performance of a semiconductor device. For examples, impurities can damage circuits rendering a semiconductor device unusable or negatively affect its performance. In the manufacture of semiconductor devices, cleaning steps are necessary to wash away any residual foreign matter. Hydrofluoric acid is regularly used as a cleaning solution. Given the worldwide demand for semiconductor devices, the large volumes of semiconductor devices manufactured results in the manufacturing process producing streams of hydrofluoric acid waste in large volumes.

Cryolite, also referred to as sodium hexfluoroaluminate, has the chemical formula Na₃AlF₆ and is a somewhat uncommon mineral. Molten cryolite is used as a solvent for production of aluminum oxide in the Hall-Heroult process. Cryolite is also used in the refining of aluminum. Cryolite decreases the melting point of aluminum oxide from 2000 to 2500° C. to 900-1000° C., and increases its conductivity, thus making the extraction of aluminum more economical. Cryolite occurs as glassy, colorless, white-reddish to gray-black prismatic monoclinic crystals. It has a Mohs hardness of 2.5 to 3 and a specific gravity of about 2.95 to 3.0. Cryolite is translucent to transparent with a very low refractive index of about 1.34. Cryolite is also used as an insecticide and pesticide and to give fireworks a yellow color.

In accordance with embodiments of the present disclosure, waste hydrofluoric acid from a semiconductor processing facility is converted to cryolite through a reaction with an aluminate sodium compound, e.g., sodium aluminate (NaAlO₂). This reaction is represented by the chemical equation:

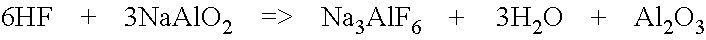

The above reaction utilizes fewer raw materials and can be carried out at temperatures, typically lower than other reactions that can be used to produce cryolite. For example, one such other reaction includes pretreating hydrofluoric acid waste to produce semi-finished products such as fluorite or gaseous hydrogen fluoride. These additional pre-treatments can be dangerous and require an extremely high temperature reaction environment. Cryolite can also be produced from hydrofluoric acid in a fluidized bed. In order to achieve a controlled outlet concentration of hydrofluoric acid using a fluidized bed, continuous reflux is required and the bed can be quite tall, thereby taking up valuable manufacturing floor space. Another drawback of producing cryolite in a fluidized bed is that the upper limit of the inlet concentration of hydrofluoric acid is low, e.g., in the low single digits and preprocessing of the hydrofluoric acid is required.

The present disclosure describes methods and systems for converting waste hydrofluoric acid (e.g., from a semiconductor processing facility) to cryolite. The waste hydrofluoric acid can be obtained from waste hydrofluoric acid resulting from the manufacture and processing of semiconductor devices. In some embodiments, the sources of hydrofluoric acid are sources of hydrofluoric acid waste. In other embodiments, the sources of hydrofluoric acid provide hydrofluoric acid that is not a hydrofluoric acid waste. The conversion of the hydrofluoric acid to cryolite reduces the need to dispose of large volumes of the hydrofluoric acid and produces a useful in product. Cryolite can be used as flux in the aluminum producing industry and can help to reduce energy consumption by more than 25% in an electrolytic aluminum smelting process. Given that the global production of natural cryolite is scarce and most cryolite is mined, using methods and systems of the present disclosure to produce high purity cryolite will be beneficial to the aluminum industry and other industries. The methods and systems can be implemented in a semiconductor device fabrication facility, thus saving the costs of transportation of the hydrofluoric acid to off-site locations for further processing or disposal. The systems and methods described herein are also able to convert the hydrofluoric acid to cryolite at reduced reaction temperatures, for example, in the range of 30 to 90° C. The produced cryolite is of a commercial grade purity and can be consistently produced using hydrofluoric acid from multiple different sources, includes sources or hydrofluoric acid waste, within a semiconductor device fabrication facility. In some embodiments, systems and methods described herein, utilize waste hydrofluoric acid from two or more different sources wherein the waste hydrofluoric acids have different properties, e.g., different concentrations or different HF contents.

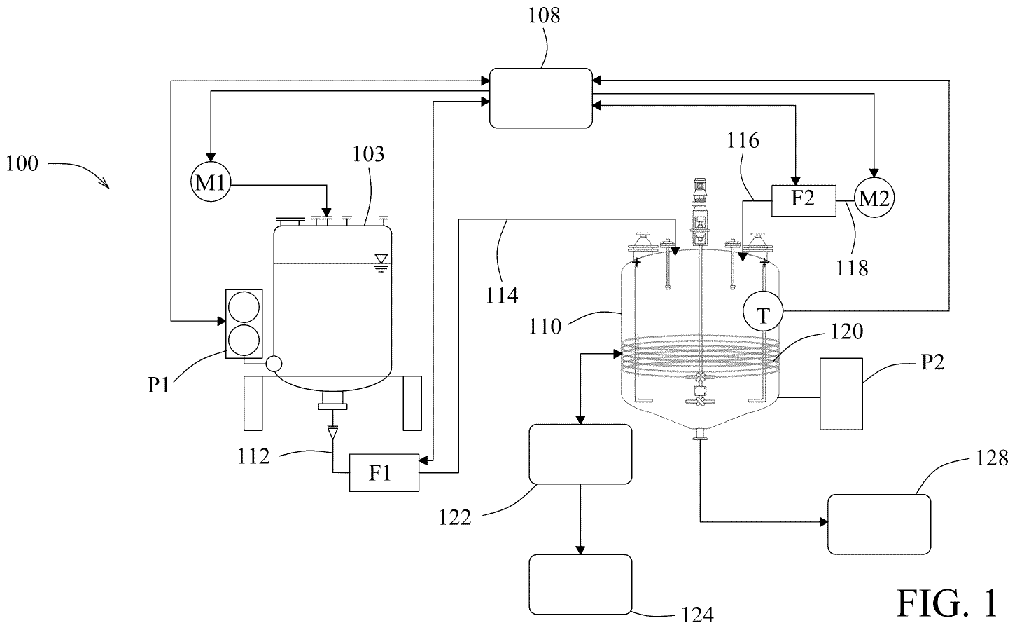

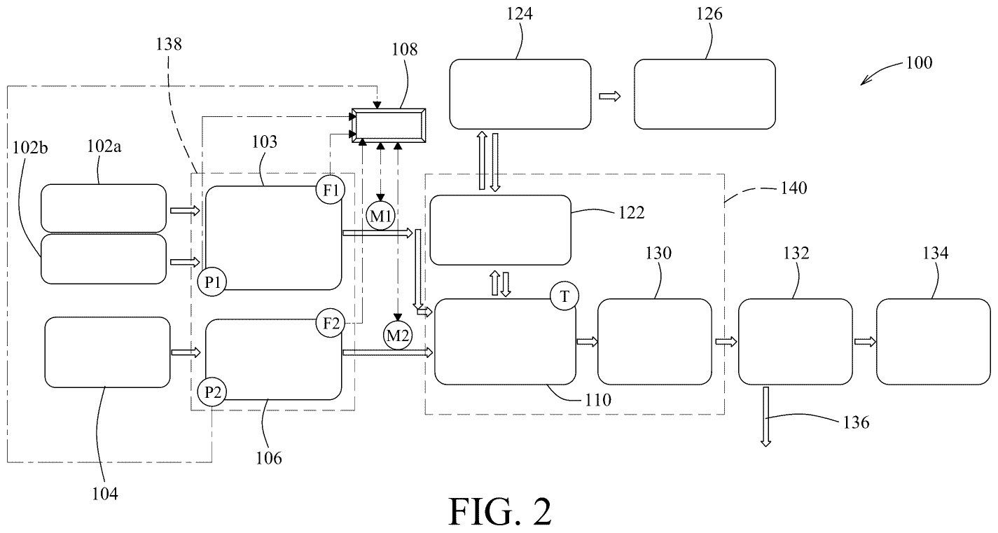

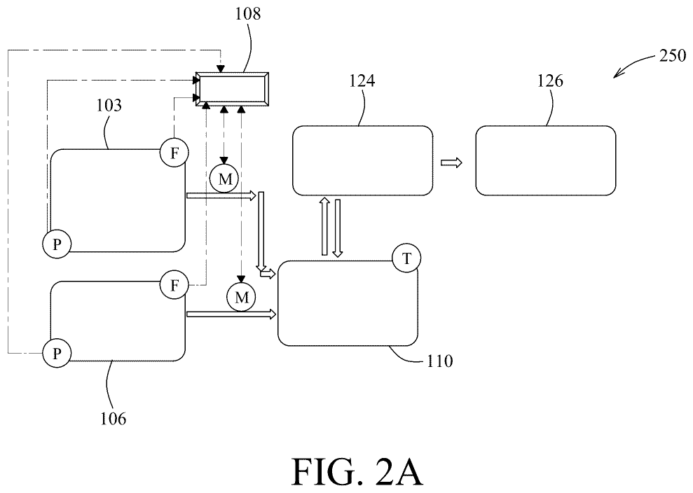

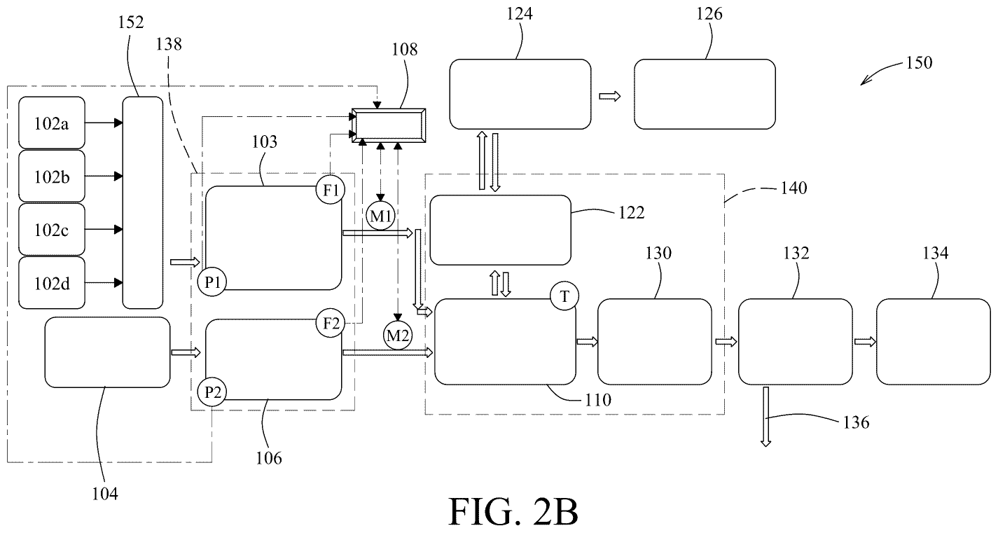

Referring to FIGS. 1 and 2, an embodiment of a system 100 for converting waste streams of hydrofluoric acid to cryolite is illustrated. In the remaining description of embodiments in accordance with the present disclosure, the hydrofluoric acid is referred to as waste hydrofluoric acid; however, as noted above, embodiments in accordance with the present disclosure are not limited to utilizing waste streams of hydrofluoric acid. In other words, embodiments in accordance with the present disclosure include systems and methods for producing cryolite from hydrofluoric acid obtained from streams that are not hydrofluoric acid waste streams. FIG. 1 is a PID diagram showing various components of system 100. FIG. 2 is a schematic illustration of system 100 with further details of various components and subsystems of system 100. Referring to FIG. 2, system 100 includes multiple sources of hydrofluoric acid waste, represented by hydrofluoric acid waste source 102a and hydrofluoric acid waste source 102b. In FIG. 2, two waste sources of hydrofluoric acid 102a and 102b are illustrated. In other embodiments, system 100 includes more than two sources of hydrofluoric acid (waste or non-waste hydrofluoric acid) or in other embodiments includes less than two waste sources of hydrofluoric acid. Examples of sources of waste hydrofluoric acid in a semiconductor fabrication facility include etching unit operations or cleaning unit operations. Embodiments in accordance with the present disclosure are not limited to these sources of waste hydrofluoric acid. In accordance with embodiments of the present disclosure, waste hydrofluoric acid can be provided from sources other than etching unit operations or cleaning unit operations in a semiconductor device fabrication facility. Sources 102a and 102b are in fluid communication with an inlet of a hydrofluoric acid collection vessel 103 which serves as a receptacle for receiving and holding waste hydrofluoric acid from different sources. As described in more detail below, an outlet of hydrofluoric acid collection vessel 103 is in fluid communication with an inlet of a reactor 110.

System 100 illustrated in FIG. 2 also includes a source 104 of reactant suitable for reacting with the waste hydrofluoric acid to produce cryolite. An example of a reactant suitable for reacting with hydrofluoric acid to produce cryolite in accordance with embodiments of the present disclosure is sodium hexafluoroaluminate (NaAlO₂). An outlet of source 104 of reactant is in fluid communication with an inlet of reactant vessel 106. In the embodiment of FIG. 2, source 104 and reactant vessel 106 are illustrated as distinct vessels. In other embodiments, reactant source 104 and reactant vessel 106 can be a single vessel. As described in more detail below, an outlet of reactant vessel 106 is in fluid communication with an inlet of reactor 110.

Hydrofluoric acid collection vessel 103 is associated with a device PI for determining an amount of hydrofluoric acid contained in hydrofluoric acid collection vessel 103. The amount of hydrofluoric acid contained in hydrofluoric acid collection vessel 103 can be expressed in units of mass or units of volume. For example, in some embodiments, device PI is configured to determine a mass of hydrofluoric acid contained in hydrofluoric acid collection vessel 103. In other embodiments, device P1 is configured to determine a volume of hydrofluoric acid contained in hydrofluoric acid collection vessel 103. An example of a device capable of determining a mass of hydrofluoric acid contained in hydrofluoric acid collection vessel 103 is a load cell. Load cells convert a force, such as tension, compression, pressure or torque into an electrical signal representative of the mass of a container placed on the load cell. Embodiments in accordance with the present disclosure are not limited to the use of a load cell for the purpose of determining the mass of hydrofluoric acid in hydrofluoric acid collection vessel 103. For example, other devices for determining the mass of hydrofluoric acid in hydrofluoric acid collection vessel 103 can be utilized. Load cells can also be used to determine a volume of hydrofluoric acid in hydrofluoric acid collection vessel 103 by utilizing the mass detected by the load cell and converting that mass to a volume utilizing the known density of the hydrofluoric acid contained in the collection vessel 103. Other devices can be used to determine the volume of hydrofluoric acid in hydrofluoric acid collection vessel 103. For example, continuous flow level transmitters, differential pressure transmitters, radar level transmitters, radiofrequency transmitters or ultrasonic level transmitters can be utilized to determine the volume of hydrofluoric acid in hydrofluoric acid collection vessel 103. In some embodiments, the hydrofluoric acid collection vessel 103 is associated with a single load cell and in other embodiments, multiple load cells are associated with hydrofluoric acid collection vessel 103 for redundancy and/or averaging.

In some embodiments, a load cell P2 (for determining mass or volume of reactant) or device for determining a volume of reactant in reactant vessel 106 is associated with reactant vessel 106 and is configured to determine an amount of reactant in the vessel 106 utilizing techniques similar to those described above for determining a mass or volume of hydrofluoric acid contained within the hydrofluoric acid collection vessel 103.

System 100 includes a chemical analyzer F1, e.g., a chemical analyzer capable of determining an amount of hydrogen fluoride in hydrofluoric acid, e.g., a concentration of hydrogen fluoride in the hydrofluoric acid. In FIG. 1, an inlet of chemical analyzer F1 is in fluid communication with hydrofluoric acid collection vessel 103 via piping 112. An outlet of chemical analyzer F1 is in fluid communication via piping 114 with reactor 110 as described below in more detail. In other embodiments, chemical analyzer F1 can be integrated with hydrofluoric acid collection vessel 103 as illustrated in FIG. 2, thus eliminating the need for piping 112. Chemical analyzer F1 is able to determine the amount of hydrogen fluoride in the hydrofluoric acid contained in hydrofluoric acid collection vessel 103. For example, chemical analyzer F1 can determine the concentration of hydrogen fluoride (e.g., wt %, molarity, molality or ppm) in the hydrofluoric acid. In some embodiments, chemical analyzer F1 has a sensitivity that allows it to measure concentrations of hydrogen fluoride between about 10 to 50 weight percent in the hydrofluoric acid. In other embodiments, chemical analyzer F1 is able to determine concentrations of hydrofluoric acid in solution ranging between 15 and 45 weight percent. Chemical analyzer F1 is able to determine the foregoing concentrations of hydrofluoric acid in solution at temperatures at which the hydrofluoric acid is contained within hydrofluoric acid waste collection vessel 103. Chemical analyzer F1 is made from materials resistant to degradation by hydrofluoric acid at concentrations to be analyzed within analyzer F1. In some embodiments, a second chemical analyzer F2 is provided to analyze concentration (e.g., wt %, molarity, molality or ppm) of reactant contained in reactant vessel 106 and eventually introduced into reactor 110. In the embodiment illustrated in FIG. 1, an outlet of second chemical analyzer F2 is in fluid communication with reactor 110 via piping 116. An inlet of second chemical analyzer F2 is in fluid communication with a source of reactant (not shown in FIG. 1) via piping 118. In some embodiments, as illustrated in FIG. 2, second analyzer F2 can be integrated with reactant vessel 106, this eliminating need for piping 118. Hydrofluoric acid waste collection vessel 103, reactant vessel 106, hydrofluoric acid collection vessel load cell P1, reactant vessel load cell P2 and hydrofluoric acid collection vessel chemical analyzer F1 comprise a quantitative analysis subsystem 138. In other embodiments, quantitative analysis subsystem 138 further includes reactant vessel chemical analyzer F2.

An outlet of hydrofluoric acid waste collection vessel 103 is in fluid communication with an inlet of reactor 110. The quantity of hydrofluoric acid flowing from hydrofluoric acid waste collection vessel 103 to reactor 110 can be controlled by a flow meter M1 located between hydrofluoric acid waste collection vessel 103 and reactor 110. Flow meter M1 is communicatively coupled to controller 108. An outlet of reactant vessel 106 is in fluid communication with an inlet of reactor 110. Flow of reactant from reactant vessel 106 to reactor 110 can be controlled by a flow meter M2 between reactant vessel 106 and reactor 110. Flow meter M2 is communicatively coupled to controller 108. In embodiments illustrated in FIGS. 1 and 2, a single controller 108 is illustrated. Embodiments in accordance with the present disclosure are not limited to a single controller 108. In other embodiments, multiple controllers can be utilized.

Reactor 110 is a vessel within which waste hydrofluoric acid and reactant are combined and allowed to react and form cryolite. Reactor 110 is formed from a material which is resistant to degradation by hydrofluoric acid and reactant introduced therein as well as resistant to degradation by the formed cryolite. In accordance with embodiments illustrated in FIGS. 1 and 2, thermal energy can be removed from or introduced into reactor 110 via a combination of a heating coil 120 in FIG. 1, a coolant tank 122 and a thermal energy transfer unit 124. Reactor 110 is in thermal communication with heating coil 120 such that thermal energy can be transferred from reactor 110 to fluid contained within heating coil 120 or thermal energy from fluid contained within heating coil 120 can be transferred to reactor 110. The heating coil 120 is sized (length, diameter, surface area of contact with reactor, etc.,) so that it is capable of removing sufficient thermal energy from reactor to adjust and/or maintain the temperature of the contents of the reactor at a temperature which promotes the crystal formation of cryolite and stabilizes the purity of the formed cryolite. For example, the heating coil is sized to remove sufficient thermal energy from the contents of reactor 110 such that the temperature of the contents of the reactor is controlled to be between about 20-100° C. during the active reaction of hydrofluoric acid and reactant. In other embodiments, the heating coil 120 is sized such that the temperature of the contents of the reactor is controlled to be between about 40 to 100° C. or between 40 to 90° C. In other embodiments, the heating coil 120 is sized such that the temperature of the contents of the reactor can be controlled and maintained between 40 to 80° C. or 50 to 80° C. In some embodiments, fluid within heating coil 120 is delivered to a coolant vessel 122 where the fluid is collected. Coolant vessel 122 is in fluid communication with a thermal energy transfer unit 124 where thermal energy can be removed from the coolant or thermal energy can be introduced into the coolant. In alternative embodiments, coolant vessel 122 can be omitted and the coolant flowed directly to the thermal energy transfer unit 124 from heating coil 120. Examples of a thermal energy transfer unit 124 include a heat exchanger or similar device. In some embodiments, thermal energy transfer unit 124 is configured to convert thermal energy received from the fluid to an alternative form of energy different than thermal energy, for example electrical energy. This electrical energy can then be delivered to an alternative energy load 126. Examples of such type of a thermal energy transfer unit includes a boiler or evaporator, capable of converting a liquid to vapor. The vapor can then be used to drive an electrical power generator, e.g., a turbine. Embodiments in accordance with the present disclosure are not limited to a boiler or evaporator as a type of thermal energy transfer unit. For example, other systems or devices capable of generating electrical energy from the thermal energy of the coolant are useful in accordance with embodiments of the present disclosure. Examples of coolant useful in accordance with embodiments of the present disclosure include low boiling point compounds such as isopropyl alcohol, C₃H₅, CH₂Cl₂ and C₃H₆O. In the embodiment of FIGS. 1 and 2 reactor 110 also includes a sensor T. In one embodiment, sensor T is configured to sense temperature of the reactor 110 or contents of the reactor 110. In other embodiments, sensor T is a different type of sensor, for example, a pH sensor, a chemical analyzer for determining the concentration of hydrofluoric acid or the reactant in reactor 110, a sensor for detecting the level of fluid within reactor 110 or any other sensor capable of detecting characteristics of the reactor 110 or the contents of reactor 110 which could be useful in monitoring or controlling the formation of cryolite in reactor 110.

Outlet of reactor 110 is in fluid communication with a cryolite collection and isolation subsystem. As illustrated in FIG. 2, cryolite collection and isolation subsystem includes a cryolite collection tank 130 in fluid communication with the outlet of reactor 110. Cryolite and water are received in cryolite collection tank 130. In cryolite isolation unit operation 132, cryolite crystals are separated from water. The separated water is removed from cryolite isolation unit operation 132 via water drain 136. In accordance with embodiments of the present disclosure, the separated water has a hydrofluoric acid content of less than 10,000 ppm and in some embodiments, less than 5000 ppm. The resulting isolated cryolite is transferred from cryolite isolation unit operation 132 to a cryolite storage/delivery stage 134. Reactor 110, coolant tank 122 and temperature sensor T comprise a reaction and cooling subsystem 140.

The system 100 in FIGS. 1 and 2 include a controller 108 for controlling the production of cryolite in accordance with the methods described below in more detail. Controller 108 is in control and signal communication with load cell P1, load cell P2, chemical analyzer F1, chemical analyzer F2, flow meter M1, flow meter M2 and sensor T (not shown in FIG. 2 for clarity purposes). Controller 108 is configured to receive and/or send signals from/to load cell P1, load cell P2, chemical analyzer F1, chemical analyzer F2, flow meter M1, flow meter M2 and sensor T. Controller 108 includes memory for storing data received from load cell P1, load cell P2, chemical analyzer F1, chemical analyzer F2, flow meter M1, flow meter M2 and sensor T and for storing instructions for processing such data and providing control signals based on the processed data. In some embodiments, controller 108 is one or more programmable logic controller. In other embodiments, controller 108 is a controller that is different from a programmable logic controller, e.g., programmable logic relays.

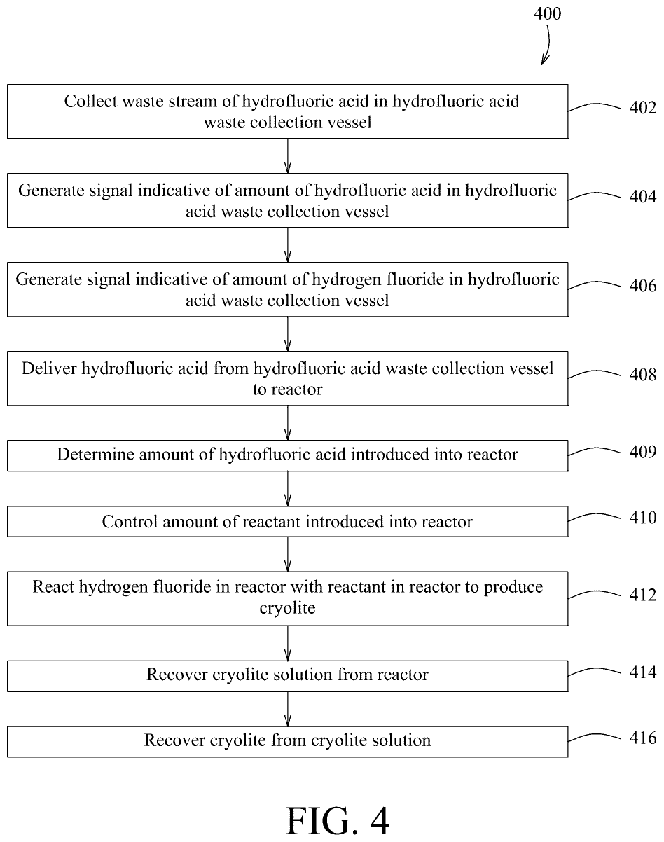

Embodiments of system 100 described above are utilized to convert hydrofluoric acid from waste streams or hydrofluoric acid from non-waste streams produced in a semiconductor fabrication facility into cryolite using embodiments of the methods described below. Referring to FIG. 4, operations of an embodiment of a method 400 for producing cryolite in accordance with the present disclosure are illustrated. Method 400 includes operation 402 of collecting hydrofluoric acid from one or more waste streams from a semiconductor fabrication facility or multiple semiconductor fabrication facilities. Operation 402 can be carried out by collecting hydrofluoric acid waste from hydrofluoric acid waste sources 102a and 102b and collecting such waste in hydrofluoric acid waste collection vessel 103. At operation 404, a signal is generated indicative of an amount of hydrofluoric acid in hydrofluoric acid waste collection vessel 103. Such signal can be generated by load cell P1 and can be, for example, a signal representative of a mass of hydrofluoric acid in hydrofluoric acid waste collection vessel 103 or a volume of hydrofluoric acid in hydrofluoric acid waste collection vessel 103. At operation 406, a signal is generated indicative of a concentration of hydrogen fluoride contained in the hydrofluoric acid in hydrofluoric acid waste collection vessel 103. The signal indicative of a concentration of hydrogen fluoride in the hydrofluoric acid contained in hydrofluoric acid waste collection vessel can be generated by chemical analyzer F1. At operation 408, hydrofluoric acid from hydrofluoric acid waste collection vessel is delivered to reactor 110. In accordance with some embodiments, concentration of the hydrogen fluoride in the hydrofluoric acid delivered to reactor 110 is between about 5 to 40 weight percent. In other embodiments, the concentration of hydrogen fluoride in the hydrofluoric acid delivered to reactor 110 is between about 8 and 30 weight percent. The flow rate of hydrofluoric acid delivered to reactor 110 can be controlled by flow meter M1. A signal representative of the amount of hydrofluoric acid or hydrogen fluoride delivered to reactor (and thereby the reaction equivalents of hydrogen fluoride delivered to reaction vessel 110) can be generated based on the length of time the flow rate of hydrofluoric acid is maintained at operation 409 and the known concentration of the hydrofluoric acid. The amount of reactant introduced into reactor 110 is controlled at operation 410. AS described below in more detail, the amount of reactant introduced into reactor 110 can be controlled by flow meter M2 and be based on the determined equivalents of hydrogen fluoride delivered to reactor 110. The hydrogen fluoride of the hydrofluoric acid and the reactant are reacted in reactor 110 to produce a solution containing cryolite at operation 412. The cryolite containing solution is recovered from reactor 110 at operation 414 utilizing, for example, cryolite collection tank 130. Cryolite is then recovered from the cryolite containing solution at operation 416 utilizing, for example, cryolite isolation unit operation 132.

In accordance with this embodiment of method 400, controller 108 controls the flow rate and the amount of reactant to reactor 110 by controlling flow meter M2 to allow a desired amount of reactant to flow into reactor 110 from reactant vessel 106 and using the flow meter M2 to monitor the amount of reactant flowed into the reactor 110. In accordance with embodiments of the present disclosure, controller 108 receives signals indicative of the amount of hydrofluoric acid in hydrofluoric acid waste collection vessel 103 from load cell P1. As noted above, load cell P1 generates a signal representative of a mass of hydrofluoric acid in hydrofluoric acid waste collection vessel 103 or a volume of hydrofluoric acid in hydrofluoric acid waste collection vessel 103. In one embodiment, when load cell generates a signal indicative of a mass (e.g., grams or kilograms) of hydrofluoric acid (i.e., hydrogen fluoride in solution) in hydrofluoric acid waste collection vessel 103, chemical analyzer F1 generates a signal indicative of the concentration of the hydrofluoric acid, e.g., grams of hydrogen fluoride/gram of solution of hydrofluoric acid, contained in hydrofluoric acid waste collection vessel 103. Controller 108 is programmed to use the signal indicative of mass of the hydrofluoric acid in hydrofluoric acid waste collection vessel 103 and the signal indicative of concentration of the hydrofluoric acid in the hydrofluoric acid waste collection vessel 103 to determine the reaction equivalents of hydrogen fluoride in the hydrofluoric acid waste collection vessel 103. The reaction equivalents of hydrogen fluoride introduced into reactor 110 is determined based on the mass or volume of hydrofluoric acid delivered to reactor 110 through flow meter M1. A volume of hydrofluoric acid delivered to reactor 10 can be determined by flow meter M1. The mass of hydrofluoric acid delivered to reactor 110 can be determined by calculating the difference between the mass of hydrofluoric acid in the hydrofluoric acid waste collection vessel 103 before hydrofluoric acid is removed from the hydrofluoric acid waste collection vessel 103 and introduced into the reactor 110 and the mass of hydrofluoric acid in hydrofluoric acid waste collection vessel 103 after flow of hydrofluoric acid from the hydrofluoric acid waste collection vessel 103 to the reactor 110 is stopped. The determined reaction equivalents of hydrogen fluoride introduced into reactor 110 is then utilized to determine a dosing of reactant for introduction into the reactor in order to achieve a desired level of conversion of hydrogen fluoride to cryolite. The determined dosing of reactant for introduction into the reactor can be determined by the controller 108. For example, in some embodiments, the dosing of reactant is guided by the equation:

$$Reactant dose ( mass ) = DF Dosing Factor ( DF ) \times concentration ( wt \% ) of hydrofluoric acid added to reactor \times mass of hydrofluoric acid added to reactor ;$$

wherein, when the concentration of the reactant (in wt %) is between about 15-45 wt %, DF ranges between about 0.01 to 0.95 in some embodiments and 0.1-0.70 in other embodiments. In other embodiments, when the concentration of the reactant (in wt %) is between about 15-45 wt %, DF ranges between about 0.1-0.50, 0.15-0.50 or 0.25-0.50. In still other embodiments, DF ranges between 0.25-0.35. Embodiments in accordance with the present disclosure are not limited to the foregoing ranges of DF. For example, if the concentration of the reactant is greater than 15-45 weight percent, the DF may be lower than the ranges described above. If the concentration of the reactant is less than 15-45 weight percent, the DF may be higher than the ranges described above.

The reactant dose can also be determined by the equation:

$$Reactant dose ( moles ) = DF Dosing Factor ( DF ) \times concentration ( molarity ) of hydrofluoric acid added to reactor \times volume of hydrofluoric acid added to reactor .$$

In accordance with the foregoing embodiment, after the reactant dose is determined by controller 108, controller 108 causes flow meter M2 to allow the desired dose of reactant to flow from reactant vessel 106 into reactor 110. Dispensing the desired dose of reactant into the reactor is controlled by knowing the concentration of reactant in reactant vessel 106 and controlling the mass or volumetric flow of reactant through flow meter M2 to provide the determined dose of reactant based on the reaction equivalents of hydrogen fluoride in reactor 110. The concentration of the reactant can be predetermined, i.e., provided by the reactant supplier or it may be determined utilizing chemical analyzer F2. The reaction equivalent of reactant contained in reactant vessel 106 can be determined based on the reactant concentration in reactant vessel 106 and utilizing load cell P2 to determine a mass or volume of reactant in reactant vessel 106.

The reaction between hydrogen fluoride and the reactant is exothermic. The reaction temperature promotes the dissolution of cryolite into the solution in the reactor 110. In some embodiments, controller 108 controls the flow rate (e.g., mass or volume per unit time) of hydrofluoric acid and reactant flowing into reactor 110 so that the thermal energy generated by the exothermic reaction between the hydrogen fluoride and the reactant maintains the temperature of the solution in the reactor 110 high enough so that the formed cryolite stays in solution and the contents of the reactor are not subjected to a thermal shock which could adversely affect the efficiency of the reaction in reactor 110.

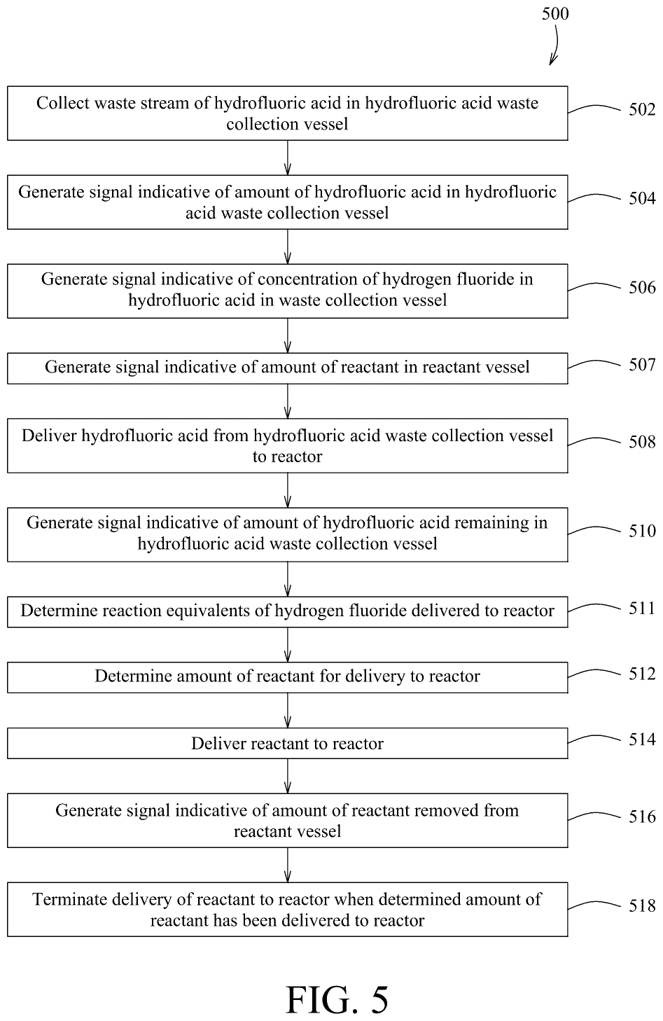

Referring to FIG. 5 in alternative embodiment of methods for producing cryolite in accordance with the present disclosure is illustrated. The embodiment of FIG. 5 differs from the embodiment of FIG. 4 in that the embodiment of FIG. 5 does not utilize flow meters to determine an amount of hydrofluoric acid or reaction equivalents of hydrogen fluoride introduced into the reactor 110 or the amount of reactant introduced into the reactor 110. In the embodiment of FIG. 5, a change in mass or volume of hydrofluoric acid in hydrofluoric acid waste collection vessel 103 and a change in mass or volume of reactant in reactant vessel 106 are utilized to determine an amount of hydrofluoric acid and an amount of reactant introduced into reactor 110. In an embodiment of method 500 of FIG. 5, method 500 includes operation 502 of collecting hydrofluoric acid from one or more waste streams in a semiconductor fabrication facility or multiple semiconductor fabrication facilities. Operation 502 can be carried out by collecting hydrofluoric acid waste from hydrofluoric acid waste sources 102a and 102b and collecting such waste in hydrofluoric acid waste collection vessel 103. At operation 504, a signal is generated indicative of an amount of hydrofluoric acid contained in hydrofluoric acid waste collection vessel 103. Such signal can be generated by load cell P1 and can be, for example, a signal representative of a mass of hydrofluoric acid in hydrofluoric acid waste collection vessel 103 or a volume of hydrofluoric acid in hydrofluoric acid waste collection vessel 103. A signal is then generated, at operation 506, indicative of a concentration of hydrogen fluoride in the hydrofluoric acid contained in hydrofluoric acid waste collection vessel 103. The signal indicative of a concentration of hydrogen fluoride in the hydrofluoric acid contained in hydrofluoric acid waste collection vessel can be generated by chemical analyzer F1 per the discussion above. Method 500 proceeds with operation 507 where a signal indicative of an amount of reactant in reactant vessel 106 is generated. Determining an amount of reactant in reactant vessel 106 and generating a signal indicative of an amount of reactant in reactant vessel 106 can be carried out utilizing load cell P2 per the discussion above. At operation 508, hydrofluoric acid from hydrofluoric acid waste collection vessel is delivered to reactor 110. Operation 510 includes generating a signal indicative of an amount of hydrofluoric acid remaining in hydrofluoric acid waste collection vessel 103. Generating a signal indicative of an amount of hydrofluoric acid remaining in hydrofluoric acid waste collection vessel 103 can be carried out utilizing load cell P1. At operation 511, the reaction equivalents of hydrogen fluoride delivered to the reactor 110 is determined. The reaction equivalents of hydrogen fluoride delivered to the reactor 110 is determined by calculating the difference between the amount of hydrofluoric acid in hydrofluoric acid waste collection vessel 103 determined at operation 504 and the amount of hydrofluoric acid in hydrofluoric acid waste collection vessel 103 determined at operation 510 to reveal the amount of hydrofluoric acid introduced into reactor 110. The reaction equivalents of hydrogen fluoride delivered to the reactor 110 is then determined using the known amount of hydrofluoric acid introduced into the reactor 110 and the hydrogen fluoride concentration of the hydrofluoric acid introduced into the reactor 110. The amount of reactant introduced into reactor 110 is determined at operation 512. Determination of the amount of reactant to be introduced into reactor 110 can be carried out utilizing the known reaction equivalents of hydrogen fluoride introduced into the reactor 110 as determined at operation 511 and the dosing equation described above. At operation 514, reactant is delivered to reactor 110 from reactant vessel 106. A signal indicative of an amount of reactant removed from the reactant vessel 106 is generated at operation 516. A signal indicative of the amount of reactant removed from the reactant vessel 106 is generated by subtracting the amount of reactant in reactant vessel 106 determined at operation 507 from the amount of reactant present in reactant vessel 106 as determined by load cell P1 at the time operation 516 is carried out. The amount of reactant removed from reactant vessel 106 is indicative of the amount of reactant introduced into reactor 110. Reactant is introduced into reactor 110 until it is determined that the amount of reactant delivered to reactor 110 corresponds to the amount of reactant determined in operation 512. For example, reactant is introduced into reactor 110 until it is determined that the determined reaction equivalents of the reactant have been introduced into the reactor 110. Once it is determined that the amount of reactant delivered to reactor 110 corresponds to the amount of reactant determined in operation 512, delivery of reactant to reactor 110 is terminated at operation 518.

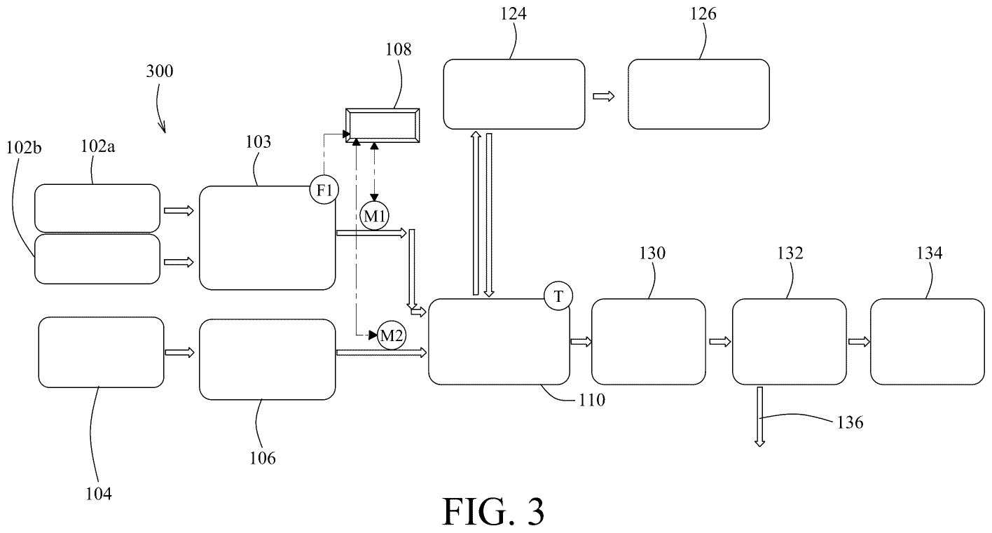

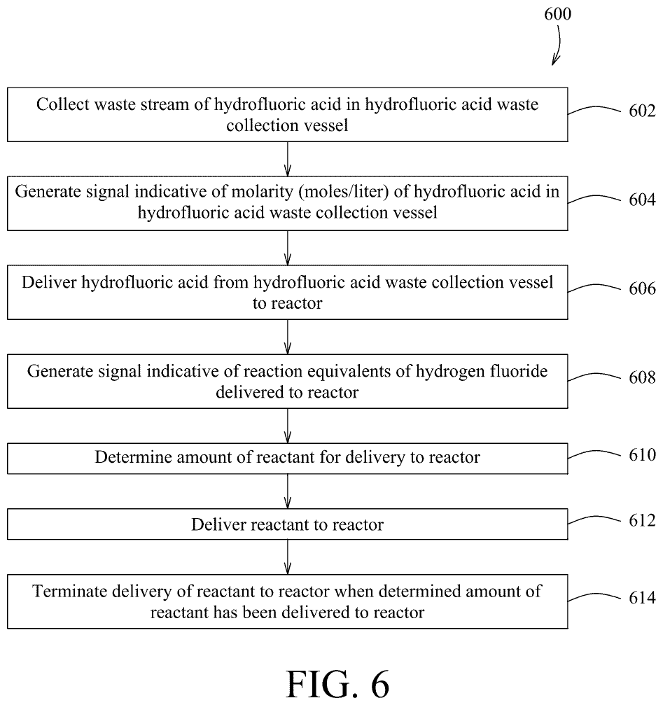

FIG. 3 illustrates an alternative system 300 for producing cryolite from hydrofluoric acid waste streams in a semiconductor fabrication facility in accordance with embodiments of the present disclosure. Embodiments in accordance with FIG. 3 are similar to the embodiments of FIGS. 1 and 2 with the exception that load cells P1 and P2 and chemical analyzer F2 are omitted. Embodiments in accordance with FIG. 3 include many of the same components as FIGS. 1 and 2. Components of FIG. 3 that are identical to components of FIGS. 1 and 2 are identified by the same reference numbers and the descriptions above regarding those components of FIGS. 1 and 2 are equally applicable to the same components of FIG. 3. As described below in more detail with reference to the method 600 of FIG. 6, in accordance with embodiments of FIG. 3, chemical analyzer F1 and flow meters M1 and M2 are utilized to generate signals indicative of the reaction equivalents of hydrofluoric acid introduced into reactor 110 and to control delivery of reactant to reactor 110 without utilizing load cells P1 and P2.

Embodiments in accordance with the method 600 of FIG. 6 begins with operation 602 of collecting a waste stream or streams of hydrofluoric acid in a hydrofluoric acid waste collection vessel, e.g., hydrofluoric acid waste collection vessel 103. The description above regarding operations 502 is equally applicable to operation 602. Method 600 proceeds with operation 604 in which signals indicative of the molarity (moles/liter) of hydrofluoric acid in hydrofluoric acid waste collection vessel 103 are generated, for example, by chemical analyzer F1. At operation 606, hydrofluoric acid is delivered from hydrofluoric acid waste collection vessel 103 to reactor 110. The description above regarding operation 408 in FIG. 4 is equally applicable to this operation 606. At operation 608, a signal indicative of the reaction equivalents of hydrogen fluoride delivered to reactor 110 is generated. The signal indicative of reaction equivalents of hydrogen fluoride delivered to reactor 110 is generated by multiplying the molarity of the hydrofluoric acid in waste hydrofluoric acid collection vessel 103 by the volume of hydrofluoric acid (as determined by flow meter M1) delivered to reactor 110. With the known reaction equivalents of hydrogen fluoride delivered to reactor 110, a reactant dose for delivery to reactor 110 can be determined at operation 610 utilizing the equation and Dosing Factor (DF) described above. Method 600 proceeds with operation 612 involving delivery of reactant to reactor 110. Delivery of reactant to reactor 110 proceeds until the determined amount of reactant has been delivered to reactor 110. Method 600 terminates at operation 614 after the determined amount of reactant has been delivered to reactor 110.

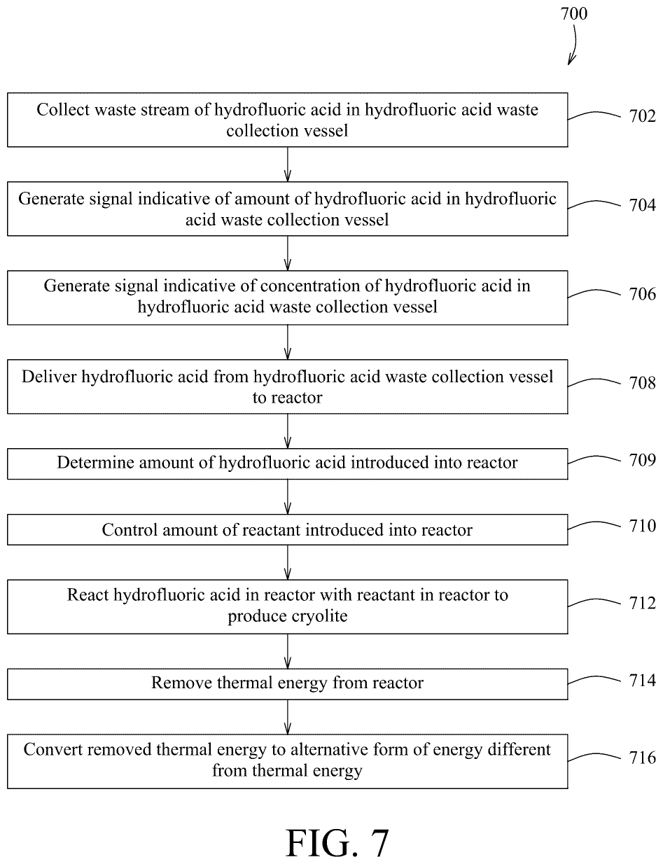

FIGS. 2A and 7 illustrate an alternative embodiment of a system and method for converting waste hydrofluoric acid to cryolite in accordance with embodiments of the present disclosure. FIG. 2A illustrates an alternative system 250 which is a modification of system 100 of FIGS. 1 and 2. System 250 differs from system 100 in that cooling medium circulating in coil 120 is delivered directly to a thermal energy transfer/conversion unit 124 without being collected in a coolant tank 122 as in FIGS. 1 and 2. Components of system 250 that are identical to components of system 100 are identified by the same reference numerals utilized in describing system 100.

System 250 and system 100 can be utilized to perform embodiments in accordance with method 700 of FIG. 7. Method 700 includes operation 702 of collecting hydrofluoric acid from one or more waste streams in a semiconductor fabrication facility or multiple semiconductor fabrication facilities. Operation 702 can be carried out by collecting hydrofluoric acid waste from hydrofluoric acid waste sources 102a and 102b and collecting such waste in hydrofluoric acid waste collection vessel 103. At operation 704, a signal is generated indicative of an amount of hydrofluoric acid in hydrofluoric acid waste collection vessel 103. Such signal can be generated by load cell P1 and can be, for example, a signal representative of a mass of hydrofluoric acid in hydrofluoric acid waste collection vessel 103 or a volume of hydrofluoric acid in hydrofluoric acid waste collection vessel 103. A signal is then generated, at operation 706, indicative of a concentration of hydrogen fluoride in the hydrofluoric acid contained in hydrofluoric acid waste collection vessel 103. The signal indicative of a concentration of hydrogen fluoride in the hydrofluoric acid contained in hydrofluoric acid waste collection vessel 103 can be generated by chemical analyzer F1. At operation 708, hydrofluoric acid from hydrofluoric acid waste collection vessel 103 is delivered to reactor 110. The flow rate of hydrofluoric acid delivered to reactor 110 can be monitored and controlled by flow meter M1. A signal representative of the amount of hydrofluoric acid delivered to reactor (and thereby the reaction equivalents of hydrogen fluoride delivered to reaction vessel 110) can be generated based on the flow rate and length of time the flow rate of hydrofluoric acid is maintained at operation 709. The amount of reactant introduced into reactor 110 is controlled at operation 710. The amount of reactant introduced into reactor 110 can be monitored and controlled by flow meter M2 based on the determined equivalents of hydrogen fluoride delivered to reactor 110. Hydrogen fluoride and reactant are reacted in reactor 110 to produce a solution containing cryolite at operation 712. In method 700, thermal energy is removed from reactor 110 by coil 120, in FIG. 1, at operation 714. The thermal energy removed from reactor 110 by coil 120 at operation 714 is converted to an alternative form of energy different from thermal energy at operation 716. This conversion of the thermal energy to an alternative form of energy different from thermal energy can be carried out by thermal energy conversion unit 124 (in FIG. 2A) and the alternative form of energy delivered to an alternative energy load 126 (in FIG. 2A).

FIG. 2B illustrates a system 150 in accordance another embodiment of the present disclosure. System 150 is identical to the system 100 described above with reference to FIG. 2. Components of system 150 that are identical to components of system 100 are identified by reference numerals that are the same as the reference numerals used in FIG. 2. System 150 differs from system 100 in that system 150 includes a waste hydrofluoric acid mixing device 152 between sources 102a, 102b, 102c and 102d of waste hydrofluoric acid. An inlet side of waste hydrofluoric acid mixing device 152 is in fluid communication with each of the multiple distinct hydrofluoric acid waste sources 102a, 102b, 102c and 102d. In accordance with embodiments of the present disclosure, these multiple distinct hydrofluoric acid waste sources provide hydrofluoric acid having different concentrations. An outlet side of waste hydrofluoric acid mixing device 152 is in fluid communication with hydrofluoric acid waste collection vessel 103. In operation, waste hydrofluoric acid mixing device 152 receives waste hydrofluoric acid from two or more of hydrofluoric acid waste sources 102a, 102b, 102c and 102d and mixes the two or more streams of hydrofluoric acid waste. Flow from hydrofluoric acid waste sources 102a, 102b, 102c and 102d to hydrofluoric acid waste mixing device 152 is controlled by valves or flow meters (not shown). Providing hydrofluoric acid mixing device 152 between the sources of waste hydrofluoric acid 102a, 102b, 102c and 102d and waste collection vessel 103 allows an operator to tailor the concentration of hydrofluoric acid delivered to hydrofluoric acid waste collection vessel 103. By mixing streams of waste hydrofluoric acid having different concentrations in waste hydrofluoric acid mixing device 152, a mixture of hydrofluoric acid having a desired concentration of hydrogen fluoride can be produced for delivery to hydrofluoric acid waste collection vessel 103 and eventually to reactor 110.

Cryolite produced in accordance with embodiments of the present disclosure exhibits an impurity content sufficiently low such that it meets commercially available standards for cryolite purity, thus making the produced cryolite suitable for industrial applications. In some embodiments, cryolite produced in accordance with embodiments of the present disclosure exhibits sodium content less than about 32 weight percent.

One embodiment, the present disclosure relates to a method for converting waste hydrofluoric acid to cryolite. Such method includes collecting the waste hydrofluoric acid in a hydrofluoric acid waste collection vessel and generating a signal indicative of an amount of hydrofluoric acid in the hydrofluoric acid waste collection vessel. A signal indicative of an amount of hydrogen fluoride in the hydrofluoric acid in the hydrofluoric acid waste collection vessel is also generated. Hydrofluoric acid from the hydrofluoric acid waste collection vessel is delivered to a reactor. An amount of reactant is introduced into the reactor and the amount of reactant introduced into the reactor is controlled by determining a dose of reactant to introduce into the reactor based on the generated signal indicative of the amount of hydrofluoric acid in the hydrofluoric acid waste collection vessel and the generated signal indicative of the amount of hydrogen fluoride in the hydrofluoric acid in the hydrofluoric acid waste collection vessel. In accordance with some embodiments, a temperature of the contents of the reactor are adjusted to control the conversion of hydrofluoric acid to cryolite.

In another embodiment, the present disclosure relates to a system for converting waste hydrofluoric acid to cryolite. Such system includes a hydrofluoric acid collection vessel, which in operation, receives waste hydrofluoric acid from two or more sources of waste hydrofluoric acid in a semiconductor device processing facility, a hydrofluoric acid analyzer operably coupled to the hydrofluoric acid collection vessel, which in operation, generates a signal indicative of a concentration of the hydrofluoric acid in the hydrofluoric acid waste collection vessel. A reactor is in fluid communication with the hydrofluoric acid collection vessel and a reactant vessel is in fluid communication with the reactor. The system includes one or more controllers, which in operation, control an amount of hydrofluoric acid from the hydrofluoric acid collection vessel introduced into the reactor and receive a signal indicative of the flow rate of hydrofluoric acid from the hydrofluoric acid collection vessel introduced into the reactor. The one or more controllers also control an amount of reactant from the reactant vessel introduced into the reactor based on the amount of hydrofluoric acid from the hydrofluoric acid collection vessel introduced into the reactor and receives a signal indicative of the flow rate of reactant introduced into the reactor.

Another embodiment of the present disclosure relates to a system for producing cryolite from hydrofluoric acid and includes a hydrofluoric acid collection vessel and a reactor. The hydrofluoric acid collection vessel operably communicates with at least one amount determining unit, which in operation, generates a signal indicative of an amount of hydrofluoric acid in the hydrofluoric acid collection vessel. The hydrofluoric acid collection vessel also operably communicates with a hydrofluoric acid analyzer, which in operation, generates a signal indicative of an amount of hydrogen fluoride in the hydrofluoric acid in the hydrofluoric acid collection vessel. The system further includes a reactor in fluid communication with the hydrofluoric acid collection vessel, a thermal energy transfer unit in thermal communication with the reactor, a reactant vessel, the reactant vessel in fluid communication with the reactor; and at least one controller, which in operation, controls an amount of reactant from the reactant source introduced into the reactor based on the signal indicative of the amount of hydrofluoric acid in the hydrofluoric acid collection vessel and the signal indicative of the amount of hydrogen fluoride in the hydrofluoric acid in the hydrofluoric acid collection vessel.

What is claimed is:

1. A system, comprising:
one or more hydrofluoric acid waste sources;
a reactant source;
a quantitative analysis subsystem in fluid communication with the one or more hydrofluoric acid waste sources and the reactant source, the quantitative analysis subsystem including:
a hydrofluoric acid collection vessel in fluid communication with the one or more hydrofluoric acid waste sources;
a reactant vessel in fluid communication with the reactant source;
a first load cell configured to, in operation, determine a first amount of hydrofluoric acid contained within the hydrofluoric acid collection vessel;
a second load cell configured to, in operation, determine a second amount of reactant contained within the reactant vessel;
a reaction and cooling subsystem in fluid communication with the quantitative analysis subsystem, the reaction and cooling subsystem including:
a reactor in fluid communication with the hydrofluoric acid collection vessel and the reactant vessel;
a heating coil within the reactor;
a coolant tank that contains a coolant, the coolant tank is in fluid communication with the heating coil;
a cryolite collection tank in fluid communication with the reactor;
a thermal energy conversion unit in fluid communication with the coolant tank;
an alternative energy load in electrical communication with the thermal energy conversion unit;
a controller in electrical communication with the first load cell and the second load cell.

2. The system of claim 1, wherein:
the reaction and cooling subsystem further includes a temperature sensor configured to, in operation, determine a temperature of the reactor; and
the controller is in electrical communication with the temperature sensor.

3. The system of claim 1, wherein:
the quantitative analysis subsystem further includes:
a first chemical analyzer configured to, in operation, determine an amount of hydrogen fluoride within hydrofluoric acid within the hydrofluoric acid collection vessel; and
a second chemical analyzer configured to, in operation, determine a concentration of reactant within the reactant vessel;
the controller is in electrical communication with the first chemical analyzer and the second chemical analyzer.

4. The system of claim 3, wherein the concentration is at least one of weight percent (w %), molarity, molarity, molality, or parts per million (ppm).

5. The system of claim 1, further comprising:
a first flow meter that is present along a first fluid pathway that extends between the hydrofluoric acid collection vessel and the reactor; and
a second flow meter that is present along a second fluid pathway between that extends between the reactant source and the reactor.

6. The system of claim 5, wherein:
the first flow meter is configured to, in operation, measure a first flow of hydrofluoric acid along the first fluid pathway; and
the second flow meter is configured to, in operation, measure a second flow of reactant along the second fluid pathway.

7. The system of claim 6, wherein:
the first flow meter is in electrical communication with the controller, and the first flow meter is configured to, in operation, control the first flow of hydrofluoric acid along the first fluid pathway; and
the second flow meter is in electrical communication with the controller, and the second flow meter is configured to, in operation, control the second flow of hydrofluoric acid along the second fluid pathway.

8. The system of claim 1, further comprising a cryolite isolation unit operation in fluid communication with the cryolite collection tank, the cryolite isolation unit operation is configured to, in operation, separate cryolite crystals from water.

9. The system of claim 8, further comprising:
a water drain in fluid communication with the cryolite isolation unit operation, the water drain is configured to, in operation, drain water from the cryolite isolation unit operation; and
a cryolite storage/delivery stage configured to, in operation, receive the cryolite crystals separated from the water in the cryolite isolation unit operation.

10. A system, comprising:
a plurality of hydrofluoric acid waste sources;
a reactant source;
a waste hydrofluoric acid mixing device in fluid communication with the plurality of hydrofluoric acid waste sources
a quantitative analysis subsystem in fluid communication with the one or more hydrofluoric acid waste sources and the reactant source, the quantitative analysis subsystem including:
a hydrofluoric acid collection vessel in fluid communication with the one or more hydrofluoric acid waste sources;
a reactant vessel in fluid communication with the reactant source;
a first load cell configured to, in operation, determine a first amount of hydrofluoric acid contained within the hydrofluoric acid collection vessel;
a second load cell configured to, in operation, determine a second amount of reactant contained within the reactant vessel;
a reaction and cooling subsystem in fluid communication with the quantitative analysis subsystem, the reaction and cooling subsystem including:
a reactor in fluid communication with the hydrofluoric acid collection vessel and the reactant vessel;
a heating coil within the reactor;
a coolant tank that contains a coolant, the coolant tank is in fluid communication with the heating coil;
a cryolite collection tank in fluid communication with the reactor;
a thermal energy conversion unit in fluid communication with the coolant tank;
an alternative energy load in electrical communication with the thermal energy conversion unit;
a controller in electrical communication with the first load cell and the second load cell.

11. The system of claim 10, wherein:
the reaction and cooling subsystem further includes a temperature sensor configured to, in operation, determine a temperature of the reactor; and
the controller is in electrical communication with the temperature sensor.

12. The system of claim 10, wherein:
the quantitative analysis subsystem further includes:
a first chemical analyzer configured to, in operation, determine an amount of hydrogen fluoride within hydrofluoric acid within the hydrofluoric acid collection vessel; and
a second chemical analyzer configured to, in operation, determine a concentration of reactant within the reactant vessel;
the controller is in electrical communication with the first chemical analyzer and the second chemical analyzer.

13. The system of claim 12, wherein the concentration is at least one of weight percent (w %), molarity, molarity, molality, or parts per million (ppm).

14. The system of claim 10, further comprising:
a first flow meter that is present along a first fluid pathway that extends between the hydrofluoric acid collection vessel and the reactor; and
a second flow meter that is present along a second fluid pathway between that extends between the reactant source and the reactor.

15. The system of claim 10, further comprising a cryolite isolation unit operation in fluid communication with the cryolite collection tank, the cryolite isolation unit operation is configured to, in operation, separate cryolite crystals from water.

16. The system of claim 15, further comprising:
a water drain in fluid communication with the cryolite isolation unit operation, the water drain is configured to, in operation, drain water from the cryolite isolation unit operation; and
a cryolite storage/delivery stage configured to, in operation, receive the cryolite crystals separated from the water in the cryolite isolation unit operation.

17. A system, comprising:
one or more hydrofluoric acid waste sources;
a reactant source;
a quantitative analysis subsystem in fluid communication with the one or more hydrofluoric acid waste sources and the reactant source, the quantitative analysis subsystem including:
a hydrofluoric acid collection vessel in fluid communication with the one or more hydrofluoric acid waste sources;
a reactant vessel in fluid communication with the reactant source;
a first load cell configured to, in operation, determine a first amount of hydrofluoric acid contained within the hydrofluoric acid collection vessel;
a second load cell configured to, in operation, determine a second amount of reactant contained within the reactant vessel;
a reaction and cooling subsystem in fluid communication with the quantitative analysis subsystem, the reaction and cooling subsystem including:
a reactor in fluid communication with the hydrofluoric acid collection vessel and the reactant vessel;
a heating coil within the reactor;
a cryolite collection tank in fluid communication with the reactor;
a thermal energy conversion unit in thermal communication with the heating coil;
an alternative energy load in electrical communication with the thermal energy conversion unit;
a controller in electrical communication with the first load cell and the second load cell.

18. The system of claim 17, wherein:
the reaction and cooling subsystem further includes a temperature sensor configured to, in operation, determine a temperature of the reactor; and
the controller is in electrical communication with the temperature sensor.

19. The system of claim 17, wherein:
the quantitative analysis subsystem further includes:
a first chemical analyzer configured to, in operation, determine an amount of hydrogen fluoride within hydrofluoric acid within the hydrofluoric acid collection vessel; and
a second chemical analyzer configured to, in operation, determine a concentration of reactant within the reactant vessel;
the controller is in electrical communication with the first chemical analyzer and the second chemical analyzer.

20. The system of claim 17, further comprising:
a first flow meter that is present along a first fluid pathway that extends between the hydrofluoric acid collection vessel and the reactor; and
a second flow meter that is present along a second fluid pathway between that extends between the reactant source and the reactor.
